(19) United States
(12) Patent Application Publication
(10) Pub. No.: US 2026/0192883 A1
(43) Pub. Date: Jul. 9, 2026

(54) PIVOTABLE SNOW FLAP

(71) Applicant: Bombardier Recreational Products, Inc., Valcourt (CA)

(72) Inventors: Esa Vaisanen, Rovaniemi (FI); Jukka Karanen, Rovaniemi (FI)

(21) Appl. No.: 19/056,320

(22) Filed: Feb. 18, 2025

Related U.S. Application Data
(60) Provisional application No. 63/742,534, filed on Jan. 7, 2025.

(51) Int. Cl. B62M 27/02

(52) U.S. Cl. CPC B62M 27/02; B62M 2027/027; B62M 2027/028

(57) ABSTRACT

A pivotable flap assembly for a vehicle may have a flap portion most distal from the frame and the flap portion being configured to achieve two different positions via a hinged connection between the flap and the rear section of the vehicle. The flap may be maintained in at least one of two positions using either a friction-type mechanical connector or an over-center mechanism coupled to the flap.

### RELATED APPLICATION DATA

The instant application claims the benefit of priority of U.S. Provisional Ser. No. 63/742,534, filed on Jan. 7, 2025, the entire disclosures of which being incorporated herein by reference in their entirety.

### FIELD OF THE INVENTION

The present invention relates to projectile snow, mud, water, or other terrain portions and mechanisms used to reduce the projection of the same during routine operation of recreational vehicles, in particular, snow flaps for snowmobiles and the like.

### BACKGROUND

In recreational vehicles, there is typically a mechanism in the rear of the vehicle to reduce projection of portions of terrain during routine operation of the vehicle. For example, a snowmobile will typically have a rear snow flap coupled to the frame, either directly or indirectly via the tunnel or components attached thereto. A snowmobile snow flap is designed, typically, to redirect snow that is projected from a drive track away from its rearward trajectory and instead displace it towards the heat exchanger or other underside of the tunnel.

With respect to snowmobiles, a typical snow flap is flexible to accommodate uneven terrain, e.g., uneven ground or deep snow. The parameters for snow flap design are usually to ensure a length that will avoid dragging the machine or hindering revolution of the drive track and a configuration that will not reduce the operating capacity (e.g., speed, drag coefficient) of the vehicle.

With respect to snowmobiles, typical snow flaps tend to interfere with the drive track when the vehicle is propelled in reverse. This is due to the fact that in deep snow, the residual snow will push the otherwise flexible snow flap forward as the vehicle propels rearward thereby pushing the snow flap into the drive track, which can result in damage to snow flap, the drive track, the vehicle, or combinations thereof. While others have tried to fortify the drive track against damage due to its flexible nature, the effect of doing so is to add weight to the vehicle and hinder the snow flap's efficiency in forward-motion use cases.

A need exists for a more optimal snowmobile rear snow flap against the problems identified above for which the art has thus far been unable to resolve.

### SUMMARY

An exemplary snow flap assembly for a vehicle having a frame may comprise a flap in the rear section of the vehicle that is capable of being held in a first position where the distal edge of the flap points towards the terrain and a second position where the distal edge of the flap points away from a tunnel of the vehicle, wherein the mechanisms used to retain the flap in each position may be toggles, hooks, grooves, magnets, hook-and-loop, over-center mechanisms, or any other type of known mechanical fastening means to those skilled in the art.

An exemplary snow flap assembly for a vehicle having a frame may comprise a flap configured to be coupled to a rear section of the vehicle, wherein the rear section to which the flap is coupled is distal to at least one motive element of the vehicle. An exemplary snow flap assembly may further comprise an over-center mechanism with at least one biased element coupled to the flap and the frame such that the at least one biased element is configured to extend and compress during pivoting of the flap with respect to the frame.

In addition to the previously described embodiment and/or as an alternative to any other described exemplary embodiment, an exemplary snow flap assembly may further comprise at least one hinged portion of the flap configured for passage of a portion of the frame therethrough.

In addition to the previously described embodiment and/or as an alternative to any other described exemplary embodiment, an exemplary snow flap assembly may further comprise at least one cover coupled to the at least one biased element.

In addition to the previously described embodiment and/or as an alternative to any other described exemplary embodiment, an exemplary snow flap assembly for a vehicle may be configured such that the at least one biased element comprises a spring.

In addition to the previously described embodiment and/or as an alternative to any other described exemplary embodiment, an exemplary snow flap assembly for a vehicle may be configured such that the frame is a tunnel.

In addition to the previously described embodiment and/or as an alternative to any other described exemplary embodiment, an exemplary snow flap assembly for a vehicle may be configured such that the at least one motive element is a drive track.

In addition to the previously described embodiment and/or as an alternative to any other described exemplary embodiment, an exemplary snow flap assembly for a vehicle may be configured such that the vehicle is a snowmobile.

In addition to the previously described embodiment and/or as an alternative to any other described exemplary embodiment, an exemplary snow flap assembly for a vehicle may be configured such that the flap may be held upwardly from the frame via the over-center mechanism.

In addition to the previously described embodiment and/or as an alternative to any other described exemplary embodiment, an exemplary snow flap assembly for a vehicle may be configured such that the flap may be held downwardly from the frame via the over-center mechanism.

In addition to the previously described embodiment and/or as an alternative to any other described exemplary embodiment, an exemplary snow flap assembly for a vehicle may be configured such that the flap may be held upwardly from the frame and the at least one motive element via the over-center mechanism.

In addition to the previously described embodiment and/or as an alternative to any other described exemplary embodiment, an exemplary snow flap assembly for a vehicle may be configured such that the flap may be held downwardly from the frame via the over-center mechanism while allowing passage of at least one structure extending outwardly from the frame.

In addition to the previously described embodiment and/or as an alternative to any other described exemplary embodiment, an exemplary snow flap assembly for a vehicle may be configured such that the flap may be held upwardly from the frame and the at least one motive element via the over-center mechanism, and the flap allows passage of at least one structure extending outwardly from the frame via a hinged portion of the flap.

An exemplary snow flap assembly for a vehicle having a frame may be operated using an exemplary method that enables pivoting a flap from a first position to a second position along a rear section of a vehicle configured to traverse a terrain. An exemplary snow flap assembly method may further comprise a step involving compressing a biased portion of an over-center mechanism. Additionally, an exemplary snow flap assembly method may further comprise a step involving positioning the flap upwardly away from the terrain following compression of the biased portion of the over-center mechanism. Additionally, and/or alternatively, an exemplary snow flap assembly method may further comprise a step involving stretching the over-center mechanism as the flap is pivoted towards the terrain. Additionally, and/or alternatively, an exemplary snow flap assembly method may further comprise a step involving positioning the flap downwardly towards the terrain.

In addition to the previously described embodiment and/or as an alternative to any other described exemplary embodiment, an exemplary snow flap assembly method may further comprise a step involving positioning the flap downwardly towards the terrain following compression of the biased portion of the over-center mechanism.

In addition to the previously described embodiment and/or as an alternative to any other described exemplary embodiment, an exemplary snow flap assembly method may involve a biased portion that also comprises a spring.

In addition to the previously described embodiment and/or as an alternative to any other described exemplary embodiment, an exemplary snow flap assembly method may involve a vehicle that is a snowmobile.

In addition to the previously described embodiment and/or as an alternative to any other described exemplary embodiment, an exemplary snow flap assembly method may involve a rear section that comprises a tunnel.

In addition to the previously described embodiment and/or as an alternative to any other described exemplary embodiment, an exemplary snow flap assembly method may involve steps in which the compression of the biased portion takes place between a joint between the over-center mechanism and the tunnel and a joint between the over-center mechanism and the flap.

Another exemplary snow flap assembly for a vehicle having a frame may be operated using an exemplary method that enables pivoting a flap connected to a tunnel of a snowmobile from a first position to a second position. An exemplary snow flap assembly method may further comprise a step involving compressing a biased portion of an over-center mechanism while being coupled to the flap and the tunnel. Additionally, and/or alternatively, an exemplary snow flap assembly method may further comprise a step involving positioning the flap in the first position, wherein the first position is either situating the flap upwardly away from the tunnel following compression of the biased portion of the over-center mechanism or situating the flap downwardly away from the tunnel following compression of the biased portion of the over-center mechanism. Additionally, and/or alternatively, an exemplary snow flap assembly method may further comprise a step involving stretching the over-center mechanism as the flap is pivoted from the first position to the second position.

In addition to the previously described embodiment and/or as an alternative to any other described exemplary embodiment, an exemplary snow flap assembly may be configured as a kit for a snowmobile such that a user of the snowmobile can practice at least one of the plurality of method steps for an exemplary snow flap assembly method.

### DESCRIPTION OF THE DRAWINGS

FIG. 1A illustrates an exemplary profile view of an exemplary recreational vehicle with an exploded view of an exemplary rear snow flap assembly in a first configuration.

FIG. 1B illustrates an exemplary profile view of an exemplary recreational vehicle with an exploded view of an exemplary rear snow flap assembly in a second configuration.

FIG. 2A illustrates an exemplary rear isometric view of the exemplary recreational vehicle of FIG. 1A and the rear snow flap oriented in the first configuration while being isolated from said view.

FIG. 2B illustrates an exemplary profile view of the exemplary rear snow flap assembly in the first configuration.

FIG. 2C illustrates an exemplary rear isometric view of the exemplary recreational vehicle of FIG. 1B and the rear snow flap oriented in the second configuration while being isolated from said view.

FIG. 2D illustrates an exemplary profile view of the exemplary rear snow flap assembly in the second configuration.

FIG. 2E illustrates another exemplary profile view of a second embodiment of an exemplary rear snow flap assembly in a first configuration.

FIG. 2F illustrates an exemplary profile view of the second embodiment of FIG. 2E, whereby the exemplary rear snow flap assembly is in the second configuration.

FIG. 3 illustrates an exemplary rear isometric sectional view of the exemplary rear snow flap assembly in the second configuration in FIG. 2C.

Each of FIGS. 3A-B illustrates an exemplary magnified profile view of the section identified by line A-A in FIG. 3.

FIG. 4A illustrates an exemplary rear isometric sectional view of another exemplary rear snow flap assembly in the first configuration.

FIG. 4B illustrates an exemplary rear isometric sectional view of another exemplary rear snow flap assembly in the second configuration.

FIG. 5A illustrates an exemplary rear isometric sectional view of another exemplary rear snow flap assembly in the first configuration.

FIG. 5B illustrates an exemplary rear isometric sectional view of another exemplary rear snow flap assembly in the second configuration.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

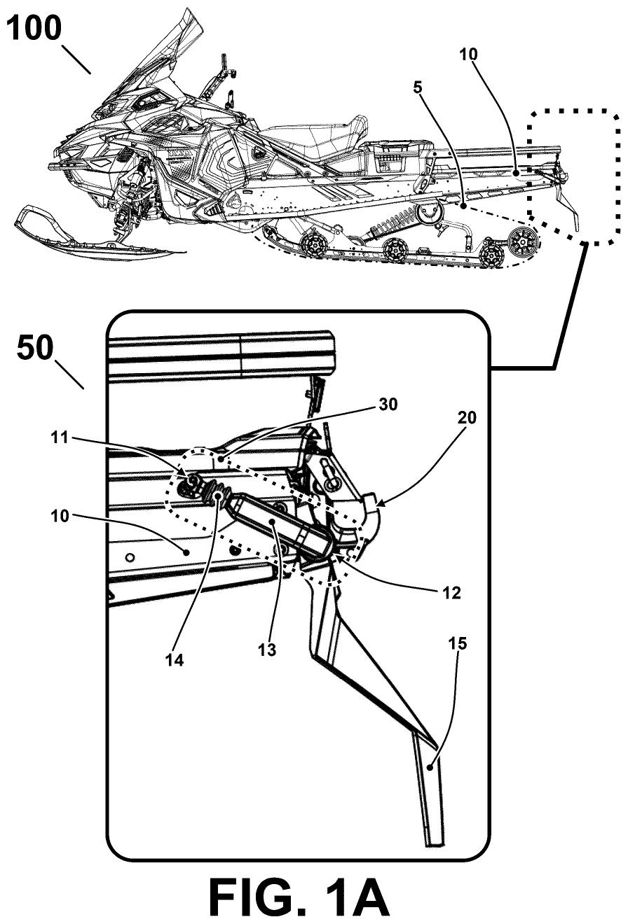

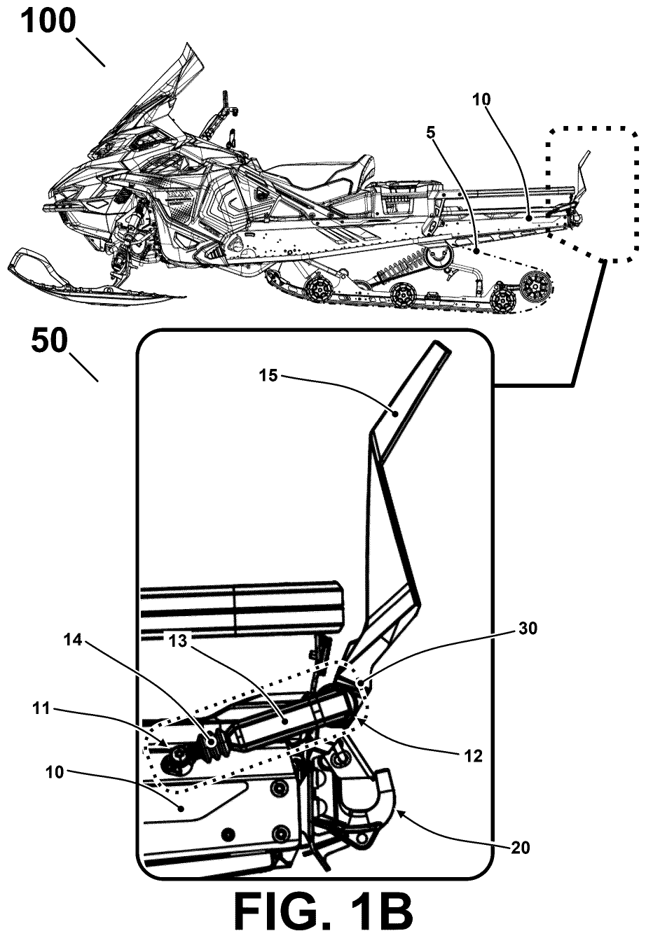

Referring to FIGS. 1A-B, an exemplary recreational vehicle 100 may be illustrated with a rear section 50. According to the illustrative embodiment of FIGS. 1A-B, where an exemplary recreational vehicle 100 is a snowmobile, rear section 50 may be that portion rearward of the motive elements, e.g., drive track 5, and/or a rearward-most part of the frame, e.g., tunnel 10. While vehicle 100 may be illustrated as a snowmobile, the disclosures herein may be applicable to other vehicles as well depending on needs.

Referring to FIG. 1A, an exemplary rear section 50 may be shown with a flap 15 operatively coupled to tunnel 10 of vehicle 100 such as by mechanical mounting, clamped fitting, or other bracing mechanisms known to those skilled in the art. According to the illustrative embodiment of FIG. 1A, an exemplary vehicle 100 may also have a hitch 20 coupled to tunnel 10. Flap 15 may be made of any material suitable for the purpose, e.g., plastic and/or rubber, and be so configured to prevent the projection of terrain, e.g., snow, and debris during vehicle 100 use. Exemplary flap 15 may be coupled to tunnel 10 via an over-center mechanism 30 comprised of a tunnel joint 11, a flap joint 12, a bias section 13, and cover 14. According to FIG. 1A, an exemplary flap 15 may be situated so that the distal-most portion of flap 15 is pointed toward the ground on which vehicle 100 is located. In configurations where flap 15 is pointed toward the terrain, the flap joint 12 of an exemplary over-center mechanism 30 may also be disposed below the upper part of the tunnel.

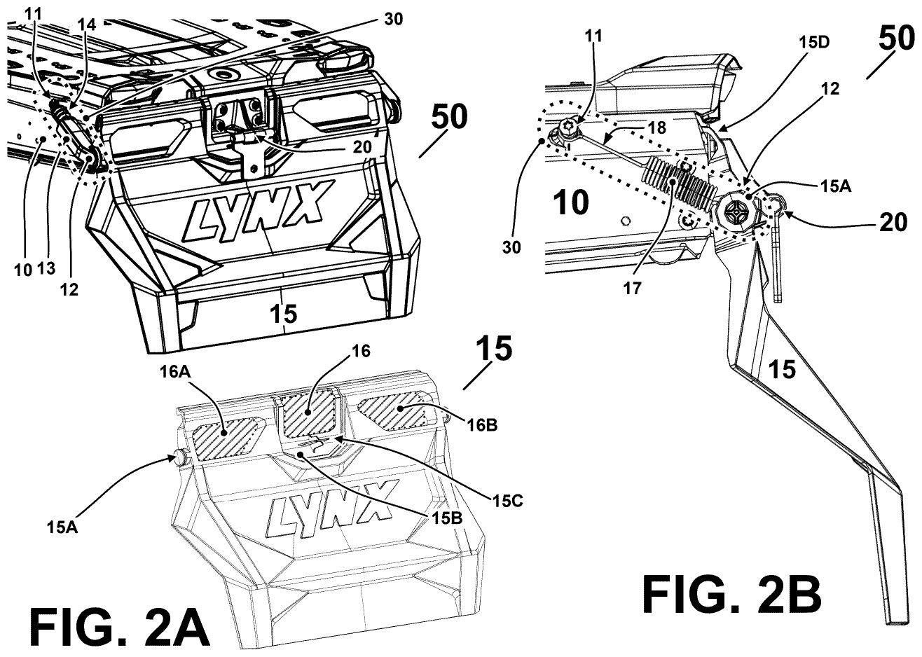

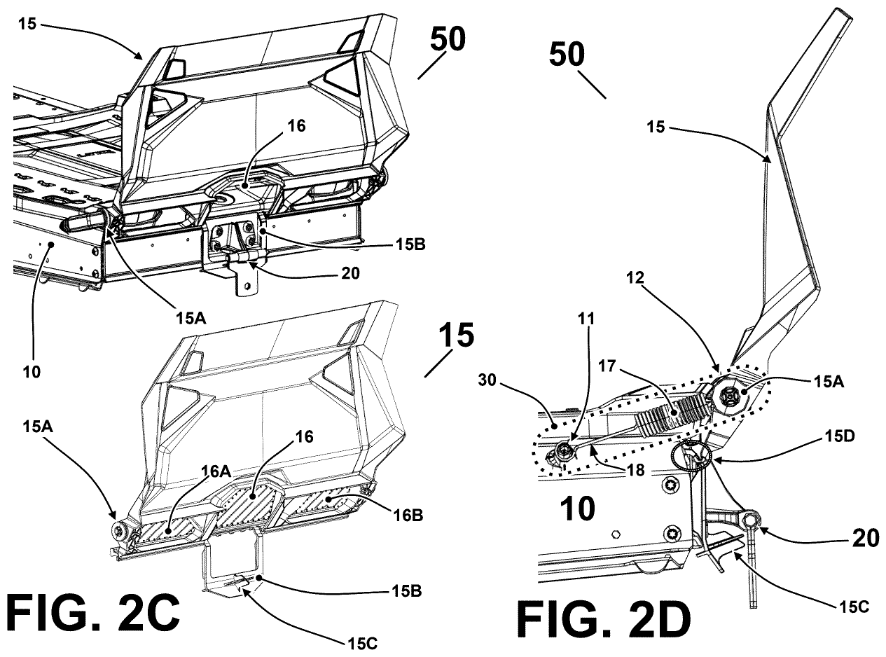

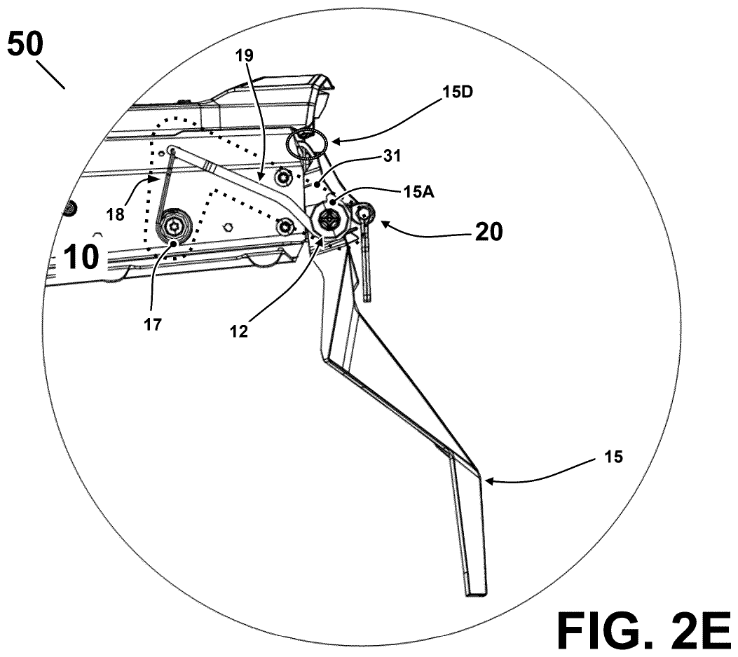

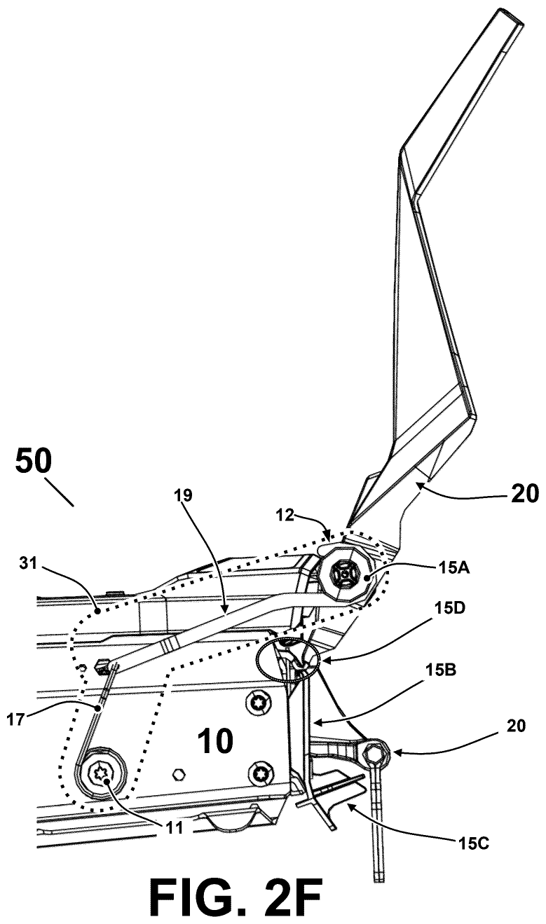

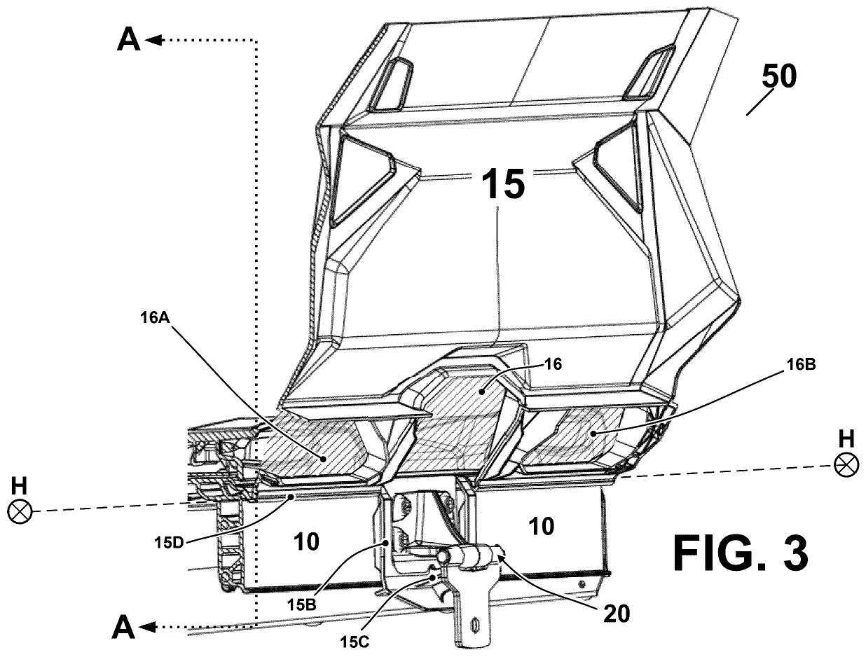

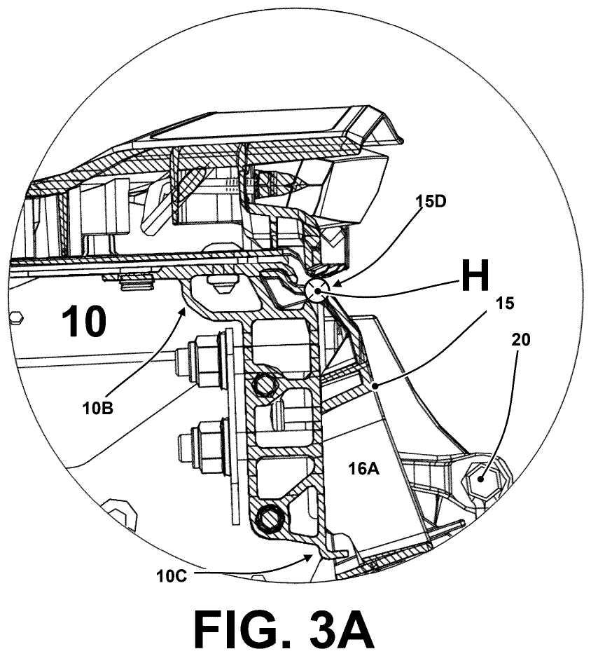

Referring to FIG. 1B, the exemplary rear section 50 of vehicle 100 is again shown with a flap 15 operatively coupled to tunnel 10. According to the illustrative embodiment of FIG. 1B, flap 15 may be disposed so that the distal-most portion of flap 15 is pointed above tunnel 10. In the illustrative position of FIG. 1B, an exemplary flap 15 may be held against gravity via the over-center mechanism 30 so as to maintain the distal-most portion of flap 15 in its over-tunnel 10 position until a force is exerted upon it to cause the distal-most portion of flap 15 to be pointed towards the terrain on which vehicle 100 is found, e.g., the illustrative positioning of flap 15 illustrated by FIGS. 1A, 2A-B, 3A. In an exemplary embodiment, the over-center mechanism 30 may have a first position wherein a bias housing 13 may enable a first compressed configuration while cover 14 may conceal the internal biasing components (to be discussed below). According to that exemplary embodiment, the over-center mechanism 30 may have a second position wherein the bias housing 13 may contain a biasing means that can be in an extended configuration while cover 14 may either remain in position or translate along the longitudinal dimension of the remainder of over-center mechanism 30. The second position may present itself when flap 15 is revolved from an upward pointing position, e.g., like the flap 15 position illustrated in FIG. 1A, to a downward pointing position, e.g., like the flap 15 position illustrated in FIG. 1B, and vice-a-versa. An exemplary over-center mechanism may be configured to resist departure of the flap 15 from a particular disposition vis-à-vis tunnel 10 by use of spring resistance, although other mechanisms may be suitable to those skilled in the art, e.g., ratcheting slots for flap joint 12, bungie cord toggles, and magnetic connectors affixed to the tunnel and located on the outside and inside surfaces of the flap 15 to resist movement during vehicle 100 operation.

Referring now to the exemplary embodiments of FIGS. 2A-B, rear section 50 may comprise an exemplary flap 15 may be shown in a downward configuration similar to that illustratively provided for in FIG. 1A. According to the embodiments illustrated in FIGS. 2A-B, an exemplary flap 15 may be coupled to tunnel 10 independently of the over-center-mechanism 30, such as being clamped, welded, or otherwise mechanically coupled thereto according to methods and mechanisms known to those skilled in the art. According to the illustrative embodiment of FIG. 2A, an exemplary flap 15 may have a tunnel coupling section 15B that may be separated-in-part and connected-in-part to the remainder of flap 15. As may be illustrated, the part of the tunnel coupling section 15B that is connected to flap 15 may be integral with the remainder of flap 15 or may otherwise be mechanically connected or chemically connected, e.g., glued, sonic welding. Tunnel coupling section 15B may have at least one window 16 through which an exemplary vehicular hitch 20 may be passed through so as not to impede the use of the hitch 20 during vehicle 100 operation. An exemplary flap stopper 15C may be disposed under an exemplary vehicular hitch 20 to enable the tunnel coupling section 15B to remain in position vis-à-vis the hitch 20 during upward/downward configurations of the flap 15, such as, when an exemplary flap 15 may be displaced via a suitable over-center-mechanism 30.

According to the same illustrative embodiment, side windows 16A and 16B may be disposed on either side of hitch window 16 to allow for viewing of vehicle 100 lights, attachment of accessories, or for other purposes. While windows 16, 16A, and 16B may be illustrated in a specific configuration, those skilled in the art may configure an exemplary flap 15 in numerous ways while still accomplishing the goals within the spirit of the disclosures herein. In an alternative embodiment, flap stopper 15C may be completely omitted from tunnel coupling section 15B. In an exemplary embodiment, windows 16A and 16B provide adequate visibility from the rear section 50 of vehicle 100 to allow others to see the lights of the vehicle 100 during use (e.g., on dark trails, in snow storms and inclement weather). In an exemplary aspect, the term “adequate visibility” when referring to the ability of lights of vehicle 100 to be adequately visible through windows 16A and 16B of an exemplary flap 15 in the first position and/or the second position, would be any configuration of flap 15, tunnel 10, windows 16A-B, and combinations of the same that enable vehicle 100 compliance with SAE J 292-2021, which is incorporated herein by reference in its entirety.

Referring now to the illustrative embodiment in FIG. 2B, an exemplary rear section 50 may show an exemplary flap 15 interconnected to tunnel 10 via a molded or clamped hinged section 15D, which may be fabricated as part of or subsequently attached to tunnel 10 during vehicle 100 assembly. Alternatively, hinged section 15D may be comprised of interlocking parts to form a rotatable connection between an exemplary flap 15 and tunnel 10, such as, for example, a door-type hinge. Alternatively, hinged section 15D may be an integral portion of the exemplary flap 15, but relatively more flexible as compared to the portions making up flap 15. In a further alternative embodiment, an exemplary hinged section 15D may have holes or openings through its thickness to allow for passage of mechanical components (e.g., bolts, rivets, screws) to allow it to be mechanically connected to tunnel 10 of vehicle 100 and avoid being dislodged during vehicle 100 operation. In the configuration of flap 15 illustrated in FIG. 2B, exemplary rear section 50 may provide an internal view of over-center mechanism 30 to expose the inside of biased section 13. According to FIG. 2B and as previously described, an exemplary bias housing 13 may comprise structure for concealing a form of extension spring 17 having at least one arm 18 designed to be rotatably affixed to tunnel 10 via tunnel joint 11. As such, an exemplary bias housing 13 may be the spring portion 17 of the design and the cover may overlap or otherwise cover arm 18. According to this illustrative embodiment, an exemplary cover 14 may be a corrugated tube, rubber gasket, or other form of deflectable structure that can reduce stresses during changes between first and second positions of the over-center mechanism 30. Alternatively, cover 14 may be rigid and merely provide protection to the underlying biasing means (e.g., spring 17) from external debris and other weather and/or contaminants. As may be further illustrated in FIG. 2B, an exemplary window 16 may provide egress for hitch 20 through the thickness of an exemplary flap 15, to enable flap 15 to be moved while avoiding hitch 20 interference.

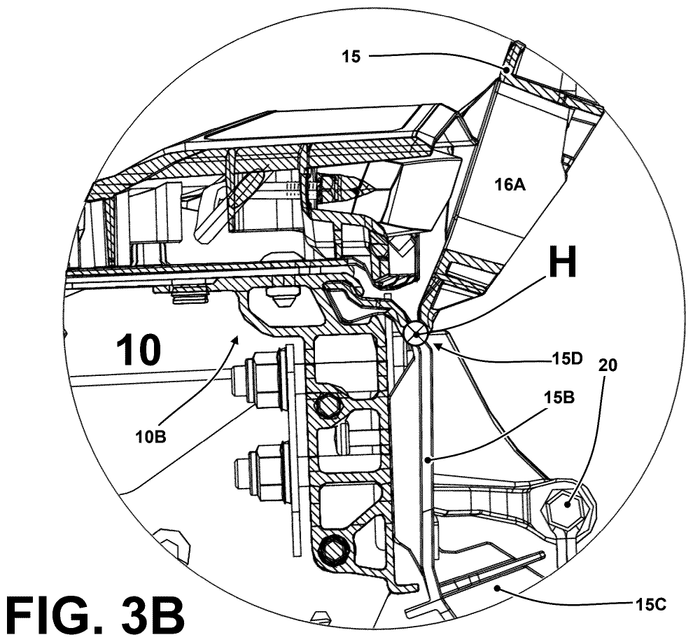

Referring now to the exemplary embodiments of FIGS. 2C-D, rear section 50 may comprise an exemplary flap 15 shown in an upward configuration similar to that illustratively provided for in FIG. 1B. According to the illustrative embodiment of FIG. 2C, an exemplary flap joint 15A may protrude outwardly from the flap-tunnel hinged portion 15D (shown in profile view in FIG. 2D). In one alternative embodiment, hinged portion 15D may be an integrated relatively flexible section of an otherwise more relatively rigid exemplary flap 15. In another alternative embodiment, an exemplary hinged portion 15D may be comprised of mechanically interconnected components, such as, like a doorway hinge or friction-fit hinged components, that allow for rotation of an exemplary flap 15 about a hinged axis “H” (as may be illustrated in FIGS. 3, 3A-B, 4A-B, and 5A-B). Additionally, hinged portion 15D may also provide additional surface area to attach an appropriately configured over-center mechanism 30 thereto. As may be illustrated in FIG. 2D, an exemplary flap 15 may be in an upward configuration whereby the distal-most portion of the flap 15 is pointed above tunnel 10 with the same exposed over-center mechanism 30 as illustrated in FIGS. 2A-B. The hinged portion 15D flap stopper 15C, and the hitch 20 may be visible in the illustrative view provided by FIGS. 2D and 2F.

Referring now to the exemplary embodiments of FIGS. 2E-F, rear section 50 may comprise an exemplary flap 15 shown in an upward configuration similar to that illustratively provided for in FIGS. 1B and 2A but utilizing a second embodiment of an over-center mechanism 31. According to the illustrative embodiment of FIG. 2E, over-center mechanism 31 may comprise a crook 19 pivotably coupled to an exemplary flap joint 15A on flap 15 and biasedly tethered to the tunnel joint 11 via a biased member 17, which may take the form of a spring, as illustrated, or may alternatively be formed of other flexibly resilient materials (e.g., a bungee material or other elastic structure that resists plastic deformation and/or is biased to return to an original shape in response to stretching). As may be illustrated in FIG. 2F, an exemplary flap 15 may be in the first position whereby the distal-most portion of the flap 15 is pointed above tunnel 10 with the same exposed over-center mechanism 31. The hinged section 15D may be visible in this illustrative view while also the flap stopper 15C and the hitch 20. The bias housing 13 and cover 14 may be applied to the components making up over-center mechanism 31 in similar manner to how it is applied to like components of over-center mechanism 30. Again, while over-center mechanisms 30 and 31 have been illustratively provided for with use of resilient springs, these mechanisms may operate without the use of springs and may otherwise take the form of other materials and structures that individually or collectively result in biased or retention-type interconnections between flap 15 and tunnel 10.

According to the illustrative embodiments depicted in FIG. 3, an exemplary rear section 50 may provide an exemplary flap 15 with a distal-most portion pointing upwardly from tunnel 10 while a section through the thickness of the flap 15 and tunnel 10 may be had along line A-A. An exemplary hinge axis “H” may be illustrated substantially through the thickness of hinge section 15D that interconnects an exemplary flap 15 to tunnel 10. Thus, an exemplary flap 15 may be in a first position that locates it above the hinge axis H, as depicted in FIG. 3. The hashed portions 16A, 16, and 16B may denote windows through which objects or lines of sight may pass through exemplary flap 15. An exemplary tunnel coupling section 15B may be visible with the associated flap stopper 15C extending upwardly therefrom while hitch 20 may protrude through the tunnel coupling section 15B. Also visible may be the hinge section 15D that is mechanically coupled to the tunnel 10 in such a way to enable flexing of flap 15 between the first and second positions whether by over-center mechanism 30/31 or other mechanical means, as well as upward and downward flap 15 configurations, such as those depicted in FIGS. 1B, 2C-D, 2F, and 1A, 2A-B, 2E respectively.

According to the embodiments illustrated in FIG. 3A, which provides a downwardly facing flap 15 along line A-A according to the embodiment illustrated in FIG. 3, an exemplary flap 15 may be shown with the hinged portion 15D located along hinge axis “H” mechanically attached to tunnel 10 via tunnel-flap coupler 10B. Additionally, an exemplary tunnel 10 may have a friction tooth or pin 10C that may mate with a portion or window 16A/B of an exemplary flap 15. In an exemplary embodiment, friction surface 10C may aid in maintaining the flap 15 in a particular position vis-à-vis tunnel 10. Alternatively, friction tooth or pin 10C may be a mounting position for electronic components/power strips/electronic devices through which access may be had via window 16A/B. Further alternatively, friction surface 10C may be interchangeable with other structures or may be a releasable locking surface, e.g., a Linq-type lock offered for sale by Bombardier Recreational Products, Inc. In such an exemplary alternative, those skilled in the art may size and shape an exemplary flap window 16, 16A-B, to allow for use of structures otherwise covered by an exemplary flap 15 while operating vehicle 100.

According to the embodiments illustrated in FIG. 3B, which provides an upwardly facing exemplary flap 15 along line A-A (e.g., distal-most portion of flap 15 pointing above hinge axis “H”) according to the embodiment illustrated in FIG. 3, an exemplary flap 15 may be shown with the hinged section 15D mechanically attached to tunnel 10 via tunnel-flap coupler 10B. In this exemplary embodiment, hinged section 15D may be shown in a deflected position, which may be one that is flexible or rigid depending on flap 15 material. For example, where the hinged portion 15D comprises a high durometer elastomer, the hinged portion 15D may provide some resistance that can only be overcome by an adequately designed over-center mechanism 30 and/or sufficiently configured mechanical retention mechanisms and/or friction fit/magnetic or other connections. Where hinged portion 15D is not as resilient, flap 15 may require an appropriately designed over-center mechanism 30/31 and/or sufficiently configured mechanical retention mechanisms and/or friction fit/magnetic or other connections to prevent unwanted deflections of a lifted flap 15 while also being capable of sufficiently yielding during flap 15 displacement.

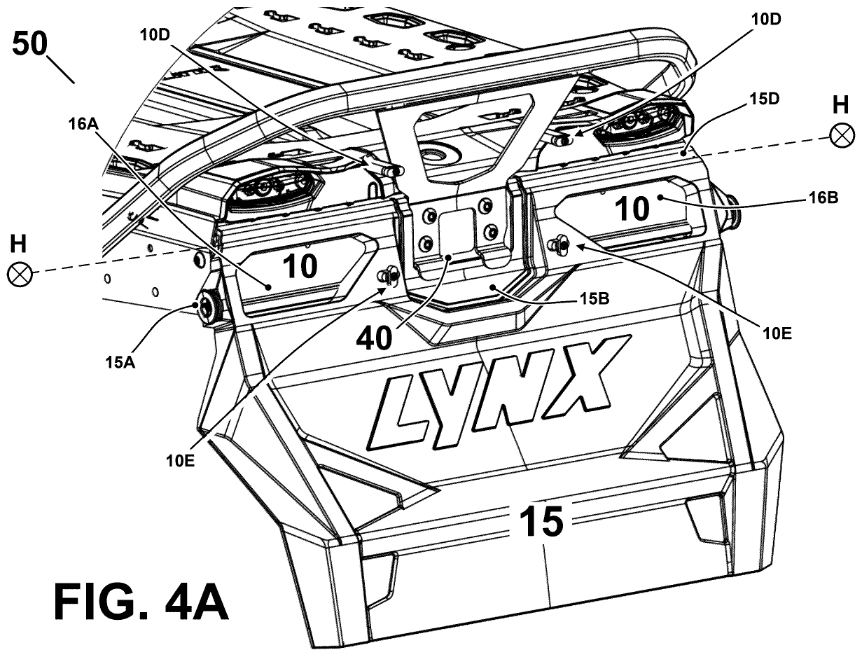

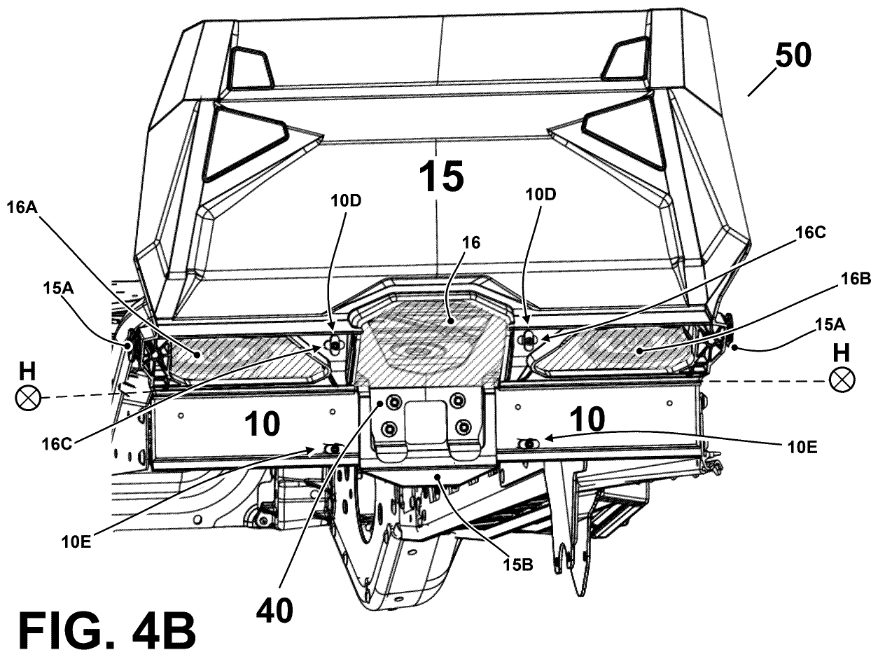

According to the illustrative embodiments depicted in FIGS. 4A-B, another alternative may be provided for maintaining an exemplary flap 15 in a plurality of positions without the need for an over-center mechanism 30/31. According to the illustrative embodiment depicted in FIG. 4A, an exemplary rear section 50 may provide an exemplary flap 15 whose hinged section 15 may be bent so as to cause the distal-most portion of flap 15 to point downwardly (e.g., the distal-most portion of flap 15 is located below hinge axis “H”) from tunnel 10 while window portions 16A and 16B may be present as spaces going through the thickness of the flap 15 so as to permit visibility of portions of tunnel 10. While tunnel 10 may be shown through window portions 16A-B, those skilled in the art may consider such portions capable of allowing passage of lights, power bars, or other such components for the vehicle for which access may be needed regardless of the positions of an exemplary flap 15. An exemplary joint 15A may be visible as well as two sets of retainer mechanisms: a lower retainer mechanism 10E retaining a first surface of exemplary flap 15 proximally to tunnel 10 in a first position (e.g., the distal-most portion of flap 15 is pointing downwardly) and an upper retainer mechanism or receiver 10D meant to retain a second surface of exemplary flap 15 in a second position that is distal from tunnel 10 (e.g., a position in which the distal-most portion of flap 15 may point upwardly away from tunnel 10).

Exemplary retainer mechanisms 10D and 10E may enable friction or snap-fit type engagement between exemplary flap 15 and corresponding portions on tunnel 10 to maintain exemplary flap 15 in an exemplary first position (e.g., the distal-most portion of flap 15 is pointing downwardly) or an exemplary second position (e.g., the distal-most portion of flap 15 is pointing upwardly and/or away from tunnel 10). Exemplary portions of tunnel 10 that may provide snap-or friction-fit engagement of exemplary flap 15 may illustrated as extensions from tunnel 10 and may be integral with tunnel 10 or added on post-fabrication of tunnel 10. Alternatively, exemplary flap 15 may have toggles, hooks, grooves, magnets, hook-and-loop, or any other type of known mechanical fastening means extending from its first or second surfaces to maintain it in a particular position vis-à-vis tunnel 10.

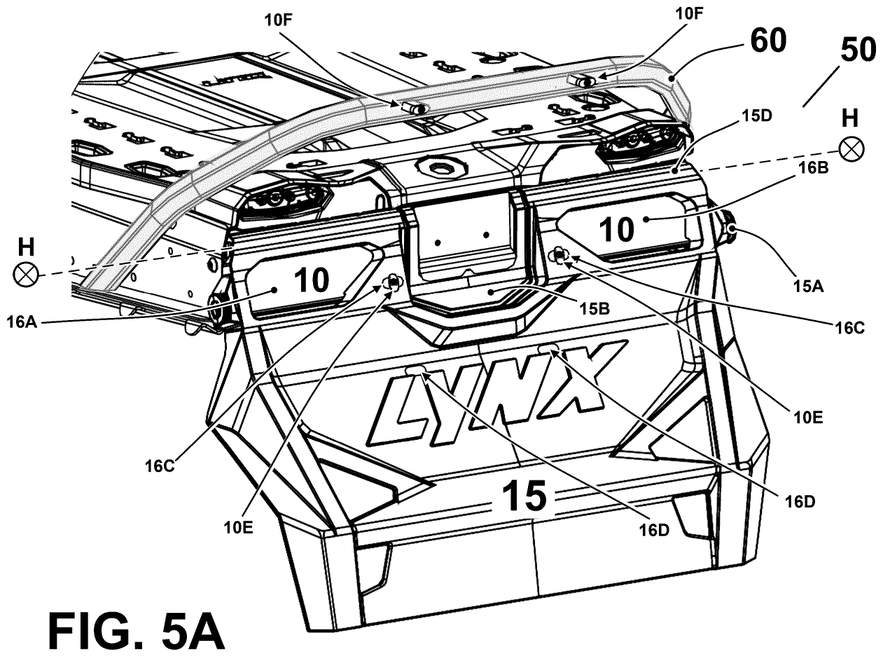

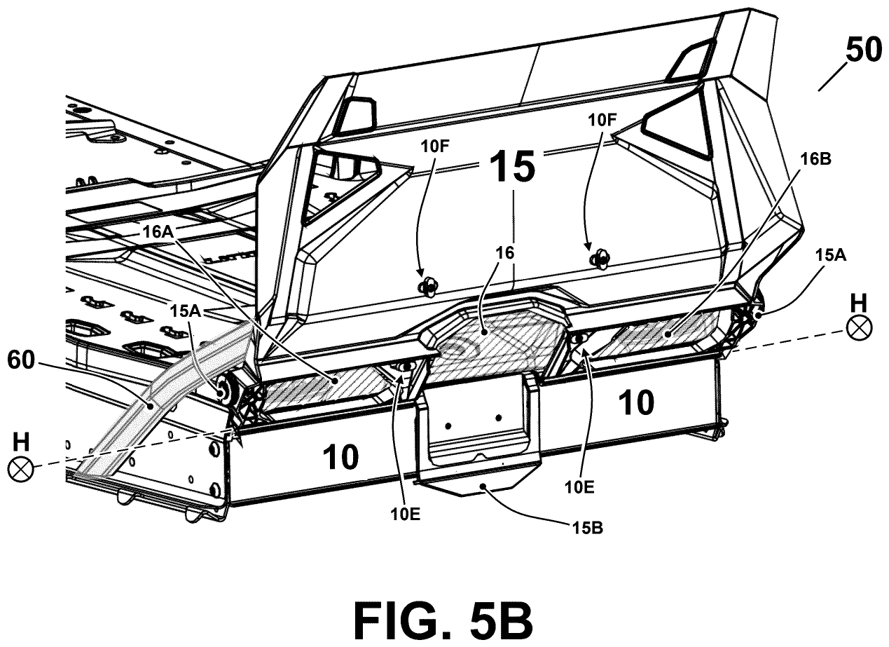

Referring to the illustrative embodiment depicted in FIG. 4B, an exemplary rear section 50 may provide an exemplary flap 15 whose hinged section 15 may be bent so as to cause the distal-most portion of flap 15 to point upwardly from the tunnel 10 (e.g., in a position located above hinge axis “H”) while window portions 16A and 16B may serve as passages through the thickness of the flap 15 so as to permit visibility of portions of tunnel 10. While tunnel 10 may be shown through window portions 16 and 16A-B. An exemplary joint 15A may be visible as well as two snap mechanisms 15E attached to a second surface, which is located opposite the first surface previously described for exemplary flap 15. Exemplary retainer mechanisms 10D, like retainer mechanisms 10E, may enable friction or snap-fit type engagement between exemplary flap 15 and corresponding portions on tunnel 10 to maintain exemplary flap 15 in the second position whereby the distal-most portion of the flap 15 is pointing upwardly. Also visible in FIG. 4B may be passes 16C, which are like windows 16A-B and 16 in that they are passages through the thickness of an exemplary flap 15. However, unlike windows 16A-B, an exemplary pass 16C may be the conduit through which one or more retainer mechanisms 10D and/or 10E may pass to maintain an exemplary flap 15 in either the second position or the first position, respectively. An exemplary pass 16C may advantageously located on an exemplary flap 15 to allow for any retainer or receiver 10D/E on an exemplary tunnel 10 to allow for the retention of flap 15 in either of the first position or the second position without the need for several passes 16C, although such an embodiment is contemplated as illustrated by FIGS. 5A-B, to be discussed.

According to the illustrative embodiments depicted in FIGS. 5A-B, another alternative may be provided for maintaining an exemplary flap 15 in a plurality of positions without the need for an over-center mechanism 30/31, similar to those shown with respect to FIGS. 4A-B. According to the illustrative embodiment depicted in FIG. 5A, an exemplary rear section 50 may provide an exemplary flap 15 whose hinged section 15 may be bent so as to cause the distal-most portion of flap 15 to point downwardly from tunnel 10 (e.g., in a position below hinge axis “H”) while window portions 16A and 16B enable visibility through the thickness of the flap 15 to permit visual or other access to portions of tunnel 10, e.g., lights, power bars, or other features on the tunnel for which viewing may be advantageous or necessary. While tunnel 10 may be shown through window portions 16A-B, those skilled in the art may consider such portions capable of allowing passage of lights, power bars, or other such components for the vehicle for which access may be needed regardless of the positions of an exemplary flap 15. An exemplary joint 15A may be visible as well as two lower passes 16D for receiving and holding of retainer mechanisms 10F, which according to this illustrative embodiment are attached to a bumper 60. In contrast to the single pass 16C embodiment illustrated and described with respect to FIGS. 4A-B, an exemplary flap 15 may have one or more lower passes 16D that enable mechanical interaction with reception devices located distally from tunnel 10, e.g., on a bumper 60 or other such extensions from tunnel 10 known to those skilled in the art. In an alternative embodiment, a piece of cargo or other storage container affixed to tunnel 10 via known mechanical linkages (e.g., Linq® system connections), may also have such retention mechanisms 10F to engage an exemplary flap 15. Additionally, while mechanisms 10D-F may be shown as twist-and-hold type retainer mechanisms, mechanisms such as Linq® may be equally suitable depending on needs.

Exemplary retention mechanisms 10E and 10F may enable friction or snap-fit type engagement between exemplary flap 15 and corresponding portions on tunnel 10 and/or bumper 60 (whether integral with tunnel 10 or removable therefrom) to maintain exemplary flap 15 in the first position whereby the distal-most portion of flap 15 is pointing downwardly or the second position, whereby the distal-most portion of flap 15 is, pointing upwardly or away from tunnel 10, respectively. Exemplary portions of bumper 60 that may provide snap-or friction-fit engagement of exemplary flap 15 may be mechanisms that may be rotated out of plane to foreclose passage of the same through upper pass 16C and/or lower pass 16D, which may be oriented for reception of the mechanisms 10F while “in plane”. For example, an exemplary mechanism 10F (like other mechanisms herein described and/or illustrated), may be in a reception position whereby the portion most proximal to the tunnel 10 and/or bumper 60 is in a first plane and the portion most distal to the tunnel 10 and/or bumper 60 is also in the first plane. Corresponding upper pass 16D may have the same cross-section as both the proximal and distal portions of the mechanism 10F while in the reception position. In an exemplary embodiment, the distal portion of mechanism 10F may be rotated out of the first plane and into a second plane that prohibits the upper pass 16D from being able to translate across both the proximal and distal portions of the mechanism 10F. Consequently, this exemplary aspect of the mechanism 10F as illustrated in FIGS. 5A-B may allow for the ability to selectively retain exemplary flap 15 in different positions vis-à-vis tunnel 10. Alternatively, exemplary flap 15 may have toggles, hooks, grooves, magnets, hook-and-loop, or any other type of known mechanical fastening means to maintain it in a particular location vis-à-vis tunnel 10 and/or bumper 60.

Referring to the illustrative embodiment depicted in FIG. 5B, an exemplary rear section 50 may provide an exemplary flap 15 whose hinged section 15 may be bent so as to cause the distal-most portion of flap 15 to point upwardly from the tunnel 10 while window portions 16A and 16B through the thickness of the flap 15 may permit visibility of tunnel 10. While tunnel 10 may be shown through window portions 16 and 16A-B. An exemplary tunnel coupling section 15B may be visible as well as two lower passes 16D through the second surface, which is located opposite the first surface previously described for exemplary flap 15. Exemplary lower passes 16D, like upper passes 16C, may enable friction or snap-fit type engagement between exemplary flap 15 and corresponding portions on tunnel 10 and/or bumper 60 to maintain exemplary flap 15 in the second position, whereby the distal-most portion of flap 15 is pointing upwardly and/or away from tunnel 10. Exemplary portions of tunnel 10 that may provide snap-or friction-fit engagement of exemplary flap 15 may be receivers 10F which may be illustrated as extensions from bumper 60. Alternatively, exemplary flap 15 may have toggles, hooks, grooves, magnets, hook-and-loop, or any other type of known mechanical fastening means to maintain it in a particular location vis-à-vis tunnel 10. As described previously, an exemplary lower pass 16D may enable passage of receiver mechanisms 10F while the portions of receiver mechanism 10F are in the same plane and retain exemplary flap 15 when those portions are out of plane with that of lower pass 16D, such as, for example, by rotating the distal portion of the receiver 10F about an axis through the plane at an angle of about 90-degrees after passing through the thickness of flap 15.

According to the above illustrative embodiments, the retention mechanisms 10D/E/F may be located at approximately the same position on an exemplary tunnel 10 but on opposing surfaces thereof. Further alternatively, the snap-or friction-fit mechanisms 10D/E/F may be located directly on tunnel 10 or may be indirectly attached thereto via extensions or other attachments unrelated to tunnel 10 but nevertheless supported by tunnel 10, e.g., bumper 60 and/or storage containers or other cargo with similar retention mechanisms located thereon. Further alternatively, an exemplary flap 15 may have passes 16D for one type of retainer mechanism and passes 16C for another type of retainer mechanism. Additionally and alternatively, mechanisms for retaining an exemplary flap 15 in the first position or the second position may utilize friction fittings with the windows 16A-B and/or opening 16. Thus, in an exemplary embodiment, an exemplary flap 15 may utilize all such passages through its thickness to achieve the retainment methods discussed herein and enable its configuration in an exemplary first position and second position.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A pivotable flap assembly for a vehicle having a frame, comprising:
a flap having a portion most distal from the frame, the flap being configured to be coupled to a rear section of the vehicle via at least one hinged portion having a hinge axis transverse to the length of the vehicle, wherein the rear section to which the flap is coupled is distal to at least one motive element of the vehicle; and
one of a friction-type mechanical connector or an over-center mechanism coupled to the flap to maintain a portion of the flap most distal from the frame in two different positions with respect to the frame, wherein the over-center mechanism comprises at least one biased element coupled to the flap and the frame, wherein the at least one biased element is configured to enable biasing and pivoting of the flap with respect to the frame.

2. The pivotable flap assembly of claim 1, further comprising at least one window of the flap configured for passage of a portion of the frame therethrough.

3. The pivotable flap assembly of claim 1, wherein the at least one biased element comprises a spring.

4. The pivotable flap assembly of claim 1, wherein the friction-type mechanical connector is a snap-fit connector.

5. The pivotable flap assembly of claim 1, wherein the vehicle is a snowmobile.

6. The pivotable flap assembly of claim 1, wherein the flap portion most distal from the frame is configured to be held at or above the hinge axis when the vehicle is placed on flat level ground.

7. The pivotable flap assembly of claim 1, wherein the flap portion most distal from the frame is configured to be held downwardly from the frame via the over-center mechanism.

8. The pivotable flap assembly of claim 1, wherein the flap portion most distal from the frame is configured to be held upwardly from the frame and the at least one motive element via the over-center mechanism.

9. A method for pivoting a portion of a flap coupled to a rear section of a vehicle via a hinge axis, wherein the portion is the most distal portion of the flap from the vehicle and the most distal portion is configured to achieve a first position to a second position, the method comprising the steps of:
positioning the most distal portion of the flap above the hinge axis;
positioning the most distal portion of the flap below the hinge axis; and
retaining the most distal portion of the flap either above or below the hinge axis.

10. The method of claim 9, wherein the step of positioning the flap above the hinge axis includes compressing a biased portion of an over-center mechanism.

11. The method of claim 9, wherein the step of positioning the flap above the hinge axis includes mechanically connecting the flap to a portion of the rear section of the vehicle.

12. The method of claim 11, wherein the portion of the rear section of the vehicle is a tunnel.

13. The method of claim 11, wherein the portion of the rear section of the vehicle is a bumper.

14. The method of claim 9, wherein the over-center mechanism interconnects a joint of the flap to a portion of the rear section of the vehicle.

15. The method of claim 14, wherein the portion of the rear section of the vehicle is a tunnel.

16. The method of claim 12, wherein the vehicle is a snowmobile.

17. The method of claim 15, wherein the vehicle is a snowmobile.

18. The method of claim 10, wherein the step of compressing the biased portion takes place between a joint between the over-center mechanism and the tunnel and a joint between the over-center mechanism and the flap.

19. A kit for a snowmobile configured to practice the method of claim 9.

20. A snowmobile comprising:
a frame comprising a tunnel having a proximal end and a distal end, the distal end of the tunnel comprising a rear section of the snowmobile;
an endless track operatively coupled to the tunnel;
a flap, the flap including a distal end and a proximal end, the proximal end being pivotally connected to the distal end of the tunnel about a hinge axis;
wherein the flap is configured to pivot about the hinge axis to achieve at least two positions with respect to the endless track, the at least two positions comprising:
a first position where the distal end of the flap is located below the hinge axis, and
a second position where the distal end of the flap is above the hinge axis, and
a biasing mechanism to bias the flap in at least one of the two positions.
